(19) United States
(12) Patent Application Publication
(10) Pub. No.: US 2008/0300987 A1
(43) Pub. Date: Dec. 4, 2008

(54) WEBSITE MONETIZATION

(75) Inventors: Nahum Rand, Las Vegas, NV (US); Vineet Joshi, Aurora, CO (US)

Correspondence Address: HOGAN & HARTSON LLP, ONE TABOR CENTER, SUITE 1500, 1200 SEVENTEENTH ST, DENVER, CO, 80202, US

(73) Assignee: InfoNow Corporation, Denver, CO (US)

(21) Appl. No.: 12/130,698

(22) Filed: May 30, 2008

Related U.S. Application Data
(60) Provisional application No. 60/941,561, filed on Jun. 1, 2007.

(51) Int. Cl. G06Q 30/00; G01S 5/00

(52) U.S. Cl. 705/14; 705/26

(57) ABSTRACT

A merchant portal accessible by a user via the Internet searches for a product using typical search techniques. The merchant portal returns to the user a list of merchants in an identified geographic location. For each listed merchant, a token is created that associates the inquiry and the merchant. Once a token has been generated, financial transactions at the merchant are monitored for the time corresponding to the life of the token. When a transaction occurs at a merchant involving the user, a report is generated associating that sale with the inquiry. Based on the sale, a fee for directing the user to the merchant is generated.

### RELATED APPLICATION

The present application relates to and claims the benefit of priority to U.S. Provisional Patent Application No. 60/941,561 filed Jun. 1, 2007, which is hereby incorporated by reference in its entirety for all purposes as if fully set forth herein.

### BACKGROUND OF THE INVENTION

1. Field of the Invention

Embodiments of the present invention relate, in general, to e-commerce and particularly to monetization of website generated sales at a brick and mortar locations.

2. Relevant Background

The Internet has revolutionized business. By providing almost instantaneous and free access to information, the use of the Internet has moved competition to a new level. No longer is consumer spending restrained by geography or overtly swayed by marketing adds found in local newspapers, magazines and the like. Consumers comfortable with using the Internet can quickly find a product and a list of merchants offering that product using a few key words. The list of merchants, which is often worldwide, can be narrowed to a list of local or regional merchants by using a few more words. Balancing the cost of shipping with the ease of visiting a retail establishment, also referred to herein as a ‘brick and mortar location’, the consumer can make an informed choice of where to purchase the product (the product or service collectively referred to herein as “goods”).

Beyond the cost of a personal computer and access fees paid to a local Internet service provider, the information provided on sites such as Yahoo, Google and the like appear free. However, a cost for such information is but hidden from the consumer. For example, when a consumer makes an inquiry regarding a product using one of the popular search engines, several websites appear almost instantaneously in response to the search. The design of these search engines is to imply that a comprehensive search has been conducted and these displayed websites represent the best fit to your inquiry. However, that is not entirely true. How one website is selected over another website for a given search is a closely guarded secret. Merchants and other business establishments contract with the search engine enterprises for considerable funds to aid in the production of a website that will increases a particular website's likelihood to be listed on the first page of an Internet search for certain goods offered in a certain region. Website design and the metadata contained therein comes at a significant cost to a merchant willing to do business or advertise on the Internet.

Search engines also contract with merchants to highlight a link to their website when a search is directed to a certain key words. Typically a key word search reveals website that most likely contain all or most of those key words within the website itself. This is referred to as an organic search. As you might expect many websites participating in the same market space may contain the same key words. For example, a search for “ping pong table” using one search engine returns 1,980,000 websites that include one or more of those three words. Of the approximately 2 millions websites responding to the inquiry only 10 are listed on the first result screen. And as one might expect the vast majority of individuals conducting such searches rarely look beyond the initially presented (the top 10 list) results. Thus, from an electronic commerce point of view, being listed on the first page of results of a search conducted on an industry sector or market of interest is very significant.

There have been multiple attempts by merchants and website providers to “game the system” and enhance one website over another. Some such techniques are successful while others are not. The reliability and appeal of a search engine is its ability to produce accurate and reliable results thus the actual processes by which the results of an organic search are generated is a closely guarded secret and one that evolves as technology changes.

Included with the organic search results, many search engines prominently display sponsored links. In the previous example “ping pong table”, three highlighted websites appear apart from the organic results. These sponsored websites meet the organic search criteria but may not necessarily be listed on the first page of results. Accordingly, for a fee, they are listed first. When a sponsored link is selected a charge occurs to the company associated with that link.

As is known to one knowledgeable in the relevant art, this fee arrangement is referred to as price, or fee per click. Every time a consumer clicks on a sponsored link generated by the search engine from an inquiry, the merchant owning that website is charged a nominal amount. That cost is eventually passed on to the consumer, but the short term effect for a merchant can be significant. Even when the merchant places a maximum on the number of clicks for which they are willing to pay, the burden can be considerable. This type of business model, though unique for its use of the Internet and search engines, is not unlike the cost of advertising in a local newspaper or magazine. An advertisement placed in a magazine may have an underlying cost for the creation and placement of the ad but the overall price to the merchant may vary based on the subscription rate of the magazine. If an ad is to be run for 6 months it is possible that, because one or two of those months are very popular, additional fees are charged to the merchant.

Beyond websites returned by organic searches and sponsored links exists millions of small enterprises that have little to no exposure to the internet and e-commerce. Many brick and mortar establishments do not have a website or if they do their ranking is such that it is often listed well off the top ten list of any plausible search. It is known, however, that one factor in ranking organic search results is the popularity of a particular website. Thus when two or more websites equally meet the search criteria sought by the searcher the more popular website will more likely rank higher in the search results. Small establishments having limited or no web presence are at a great disadvantage to compete with larger national brands that possess a national web presence.

The inherent problem with print advertisements, sponsored links, and pay-per-click fees for an Internet search is that it is near impossible and costly to determine whether a sale at particular establishment is driven by an investment in the advertisement or an investment in a website. For example, how does a merchant know that but for a website, a sale occurred? Print coupons in a local newspaper and the like have long been aimed at aiding a merchant to determine whether their advertising dollars are producing increased sales volume. But the process is inefficient in rife with risk. For example, there is no guarantee that a substantial investment in an advertisement or website design will produce any product sales. Marketing companies are keenly aware of this fact and often sell their services based on their ability to attract and direct consumers, but evidence to such increased sales volume is circumstantial at best.

Further compounding this dilemma is the existence of small local merchants trying to compete with larger enterprises. To a large mercantile or business enterprise, the cost of establishing a website is simply a cost of doing business. The website is professionally designed, contracts with search engines are established to aid in the consumer's likelihood of finding the businesses website so as to increase the likelihood that the site is preeminently displayed upon selected search criteria and costs of this process are simply lumped into overhead or cost of goods sold. Local merchants often do not possess the ability to have a website professionally designed or enter into agreements that will place that website in front of a consumer with any regularity. Furthermore, if they do invest in a website, its display to would be customers can be circumvented by the relative few number of hits the website receives as compared to national chain stores. Thus the risk of investing in such a marketing ploy is simply too high for such small merchants.

A challenge remains, therefore, to monetize advertisement dollars spent on the Internet. The ability to tie the sale of a product directly to the presence and use of a website represents a long felt need addressed by the present invention.

### SUMMARY OF THE INVENTION

A system and method for linking and monetizing website interaction with the sale of a product is herein described. According to one embodiment of the present invention, a merchant portal is created that can be accessed by a consumer via the Internet. Upon accessing the portal, a user can search for a product using typical search techniques and identify a geographic region in which the search is to be constrained. A geographic region as defined by the user can include a radius from a point of origin, a state, city, locality, zip code or other identification means by way to limit the scope of a search. By accessing a database of merchant profiles, the merchant portal returns to the user a list of merchants in the identified geographic location that provide the desired product. For each listed merchant and according to one embodiment of the present invention, a token is created that associates the user, the identified product and the merchant.

Once a token has been generated, financial transactions at each listed store are monitored for the time corresponding to the life of the token. According to one embodiment of the present invention, a financial database possessing both records of user expenditures and transactions taking place at the plurality of merchants listed is monitored by the merchant portal for a transaction consistent with the token. When a sale of a desired product identified by a user search occurs at a merchant listed on the resulting list of merchants, that sale is associated with the original inquiry. Based on the sale, a fee for directing the user to the merchant, via the original inquiry, is generated. Thus the cost of the advertisement is based on the actual sale of the product and not for simply viewing a website, advertisement or the like.

The features and advantages described in this disclosure and in the following detailed description are not all-inclusive. Many additional features and advantages will be apparent to one of ordinary skill in the relevant art in view of the drawings, specification and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of a preferred embodiment taken in conjunction with the accompanying drawings, wherein:

FIG. 1 shows a high level diagram of a system for website monetization according to one embodiment of the present invention; and

FIG. 2 shows a flowchart for one method embodiment for monetizing a website according to present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

Monetizing website interaction with regard to the sale of a product at a brick and mortar location is hereafter disclosed by way of example. A merchant portal system 100 associates the sale of a product at a particular merchant with an individual who first learned of that product by accessing the merchant portal. By generating and maintaining for a period of time a token based on a user inquiry, the cost of website interaction can be apportioned based on an actual sale.

Specific embodiments of the present invention are hereafter described in detail with reference to the accompanying Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

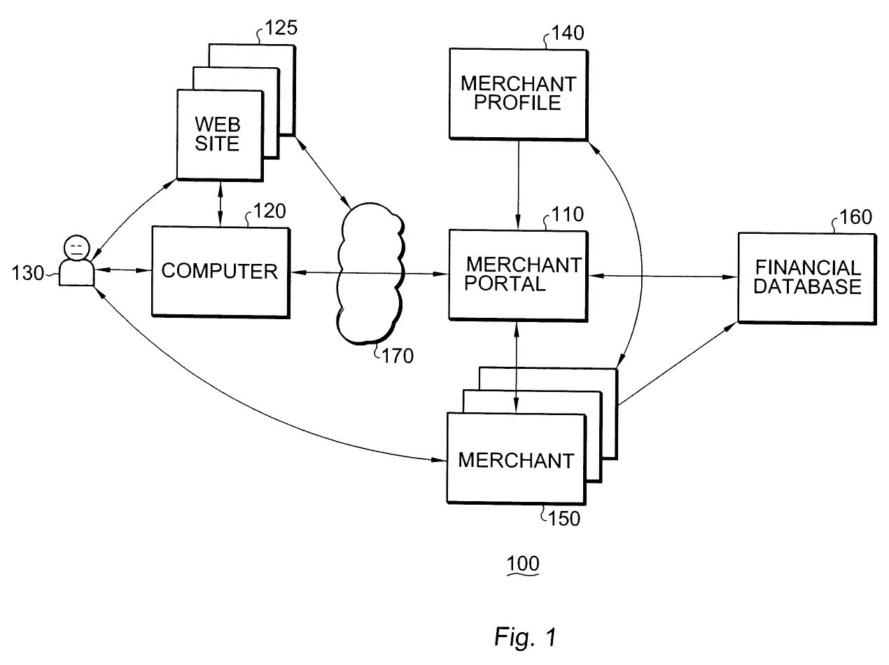

FIG. 1 shows a high level system diagram of one embodiment for website monetization according to the present invention. A merchant portal 110 is communicatively coupled to a computer 120 and/or one or more websites 125 via a wide area network 170. As one skilled the art will appreciate, the computer can be a personal computer, a personal data assistant, cellular telephone or any other device capable of interfacing with a wide area network 170 such as the Internet. The user 130 can also access the merchant portal 110 via a website 125 using the computer 120. While not shown one skilled in the relevant art will recognize that a website 125 hosting the merchant portal (or a link thereto) can be accessed by the user via the wide area network 170 using a computer 120. Similarly, the merchant portal, while described herein as a server coupled to the network 170, can be a module or engine existing on a single server or distributed over a plurality of servers according to known distributed computing technologies.

As shown in this embodiment of the present invention, the merchant portal 110 is further communicatively coupled to a merchant profile database 140 and a financial transaction database 160. Additionally, merchants 150 corresponding to the profiles present in the merchant profile database 140 are in communication with both the financial database 160 and the merchant portal 110. The configuration of the modules shown in the merchant portal system 100 depicted in FIG. 1 shows the merchant profile database 140, the financial database 160 and the plurality of merchants 150 in direct communication with the merchant portal 110. One skilled in the relevant art will recognize that other implementation methodologies and architectures for website monetization can be successfully utilized. These implementation methodologies are known within the art and the specifics of their application within the context of the present invention will be readily apparent to one of ordinary skill in the relevant art in light of this specification without departing form the scope and spirit of the present invention.

As illustrated in FIG. 1 and according to one embodiment of the present invention, a user 130 interfaces with the merchant portal using a computer 120 and/or website 125 via a wide area network 170 (the Internet). By registering with the merchant portal 110, the user 130 can submit an inquiry regarding a product or a service. According to one embodiment of the present invention, the user submits a list of key words that describes the product or service sought along with a geographic restriction. For example, the user can seek a particular type of product for a specific geographic region. Alternatively, a user can input a starting location and set a range of interest. Consider, for example, a search for deli restaurants with a ½ mile radius. By either inputting the address where the user is conducting the search or by using global positioning technology, a search can be conducted for restaurants that serve deli style food within a radius of ½ mile of the user's present location.

Upon submission of the inquiry to the merchant portal 110, the merchant portal interfaces with the merchant profile database 140 to form a list of merchants meeting the criteria submitted by the user 130. The merchant profile database 140 is populated by submissions of profiles from a plurality of merchants 150. Each merchant prepares and submits a profile including a description of the goods that the enterprise engages in selling as well as the location or locations of the merchant. While the profile is in many respects the same as an individual website for each merchant, merchants operating a brick and mortar location that do not engage in Internet based advertising or possess a website can still prepare a profile that would identify its goods and location(s) to an appropriate inquiry.

Turning back to the previous example for a search of a deli restaurant within ½ mile of the user's location, the merchant portal 110 accesses the merchant profile database 130 to gain records matching the search criteria. In this particular example, assume that the inquiry resulted in 5 merchants meeting the search criteria. In response to identifying these merchants, the merchant portal 110 conveys a list of these merchants to the user 130. At the same time of the submission of the list of merchants to the user, a token is generated and associated with each of the listed merchants and the user conducting the search.

For this example, 5 tokens are generated, one linking each merchant on the list with the user forming a unique association of the merchant and user. In addition, and according to one embodiment of the present invention, the token is tagged with a predetermined period of time during which the token remains active. At the expiration of that period, the token ceases to exist.

Thus, for the predetermined period of time, the merchant portal 110 maintains the tokens and monitors financial transactions of both the user and the listed merchants to determine whether a match consistent with the token occurs. Upon a sale at one of the listed merchants to the user, typically identified via the use of a credit card, within the predetermined period of time, the merchant portal associates that particular token with a monetization of the merchant profile (website). According to one embodiment of the present invention, financial data from the financial database 160 is utilized to reconcile the transaction. This data can be gained from a variety of sources including any or all of the participant in the financial transactions such as the purchasers, merchants or the participating financial institutions issuing financial instruments. Thereafter a charge to the merchant can be generated based on an actual sale. Rather than being charged for an inquiry or an uncertain investment in advertising, the merchant is only charged for an actual sale.

The wide area network 170 of FIG. 1 may also include mainframe computers or servers, such as a gateway computer or application server (which may access a data repository). A gateway computer serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device (such as a data repository). Depending on the application, a midrange computer may be employed.

Those skilled in the art will appreciate that the gateway computer may be located a great geographic distance from the network, and similarly, the devices may be located a substantial distance from the networks. For example, the network may be located in California, while the gateway may be located in Texas, and one or more of the devices may be located in New York. The devices may connect to the wireless network using a networking protocol such as the Transmission Control Protocol/Internet Protocol (“TCP/IP”) over a number of alternative connection media, such as cellular phone networks, radio frequency networks, satellite networks, etc. The wireless network preferably connects to the gateway using a network connection such as TCP or UDP (User Datagram Protocol) over IP, X.25, Frame Relay, ISDN (Integrated Services Digital Network), PSTN (Public Switched Telephone Network), etc. The devices may alternatively connect directly to the gateway using dial connections. Further, the wireless network and network may connect to one or more other networks (not shown), in an analogous manner.

Embodiment of the present invention can be implemented in software. Software programming code that embodies the present invention is typically accessed by the microprocessor from long-term storage media of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory, and accessed by the microprocessor using the bus. The techniques and methods for embodying software programming code in memory, on physical media and/or distributing software code via networks are well known and will not be further discussed herein.

A user of the present invention (e.g. a software installer or a software developer creating a software installation package) may connect his computer to a server using a wireline connection or a wireless connection or via a network interface. Wireline connections are those that use physical media such as cables and telephone lines, whereas wireless connections use media such as satellite links, radio frequency waves and infrared waves. Many connection techniques can be used with these various media, such as: using the computer's modem to establish a connection over a telephone line, using a LAN card such as Token Ring or Ethernet, using a cellular modem to establish a wireless connection, etc. The user's computer may be any type of computer processor, including laptop, handheld or mobile computers; vehicle-mounted devices; desktop computers; mainframe computers; etc., having processing capabilities (and communication capabilities, when the device is network-connected). The remote server, similarly, can be one of any number of different types of computer that have processing and communication capabilities. These techniques are well known in the art, and the hardware devices and software which enable their use are readily available. Herein, the user's computer will be referred to equivalently as a “workstation”, “device”, or “computer”, and use of any of these terms or the term “server” refers to any of the types of computing devices described above.

When implemented in software, the present invention may be implemented as one or more computer software programs. The software is preferably implemented using an object-oriented programming language, such as the Java programming language. In some embodiments of the present invention, the objects which are created may be specified using a number of approaches, including but not limited to: JavaBeans or objects having similar characteristics, structured markup language documents (such as XML documents), object descriptors of an object modeling notation, or Object REXX or objects in an object scripting language having similar characteristics. (“Java” and “JavaBeans” are trademarks of Sun Microsystems, Inc.) For purposes of illustration and not of limitation, the following description of preferred embodiments refers to objects which are JavaBeans.

An implementation of the present invention may be executed in a Web environment, where software installation packages are downloaded using a protocol such as the HyperText Transfer Protocol (HTTP) from a Web server to one or more target computers which are connected through the Internet. Alternatively, an implementation of the present invention may be executed in other non-Web networking environments (using the Internet, a corporate intranet or extranet, or any other network) where software packages are distributed for installation using techniques such as Remote Method Invocation (“RMI”) or Common Object Request Broker Architecture (“CORBA”). Configurations for the environment include a client/server network, as well as a multi-tier environment. Or, as stated above, the present invention may be used in a stand-alone environment, such as by an installer who wishes to install a software package from a locally-available installation media rather than across a network connection. Furthermore, it may happen that the client and server of a particular installation both reside in the same physical device, in which case a network connection is not required. (Thus, a potential target system being interrogated may be the local device on which an implementation of the present invention is implemented.) A software developer or software installer who prepares a software package for installation using the present invention may use a network-connected workstation, a stand-alone workstation, or any other similar computing device. These environments and configurations are well known in the art.

The target devices with which the present invention may be used advantageously include end-user workstations, mainframes or servers on which software is to be loaded, or any other type of device having computing or processing capabilities (including “smart” appliances in the home, cellular phones, personal digital assistants or “PDAs”, dashboard devices in vehicles, etc.).

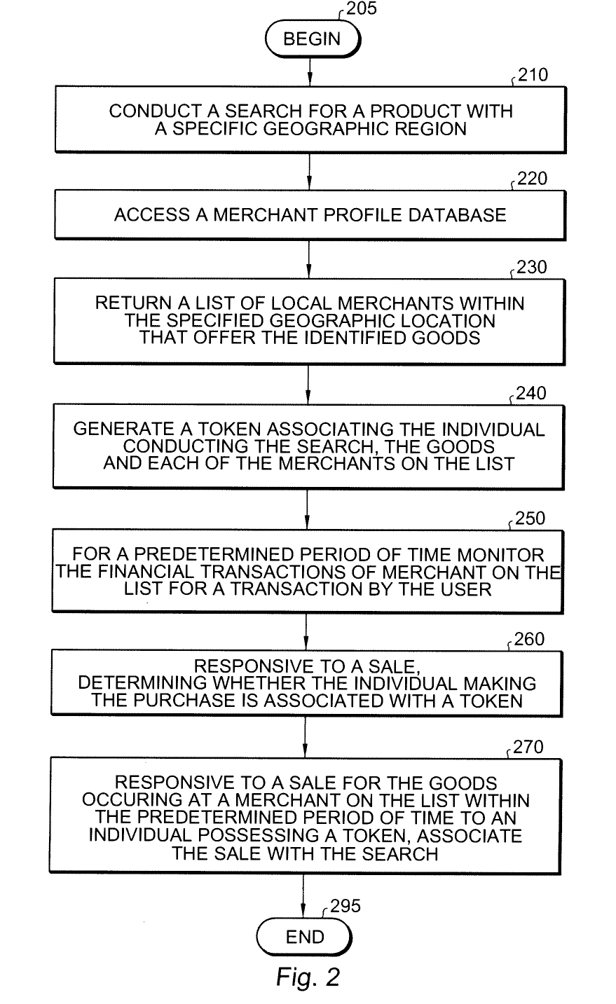

FIG. 2 is a flowchart illustrating methods of implementing an exemplary process for website monetization. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

As shown in FIG. 2, the process begins 205 with a user conducting a search 210 for goods within a specific geographic region. Prior to conducting the search, the user registers with the portal providing information that can be used to match a purchase with the inquiry. According to one embodiment of the present invention, the user can provide the last four digits of a credit card along with his or her last name. This registration establishes the user's individual financial transaction identity. Using this identity other financial transactional devices (credit cards, debit cards, ACH numbers, and the like) can be associated with the identity. Thereafter, the user logs into the merchant portal and conducts a search.

The merchant portal accesses 220 the merchant profile database and returns 230 a list of merchants within the specified geographic region that meets the specific search criteria. In addition to providing this list to the user for consideration, the merchant portal generates 240 a token for each merchant on this list associating the user with each merchant for a predetermined period of time.

During this period of time, transactions at the merchant are monitored 250 by the merchant portal as are transactions by registered users. Based on the tokens that are active, the merchant portal determines whether a transaction at a merchant by a user is associated with a token. As one skilled in the relevant art can appreciate, the implementation methodology for parsing the various data of merchant and user transactions may vary as may the matching techniques to determine whether a sale at a merchant to a user matches a search previously conducted by the user.

Responsive to a sale wherein both the user and the merchant are associated with an active token, a sale event is recorded 270. Each sale event can then be used to monetize the merchant portal. Based on the number of actual sales for goods that the merchant portal directs to a local merchant, that local merchant is charged a fee. According to one embodiment of the present invention, when no sales occur that are associated with the merchant portal, no fees are incurred. Thus the risk to the merchant for participating is minimal; only upon achieving an actual sale does any type of cost occur. According to another embodiment of the present invention, the association 260 of a sale at the merchant to a user can be further restricted to the type product purchased at the merchant. For example, as a further enticement to customers to visit the merchant's location, specific goods may be offered via the merchant profile at a substantial discount. By the user expressing interest in such a discount, the token can include data that identifies what type of product the user is seeking. Using various transactional codes, the merchant can determine whether the user conducting a sale at the merchant's location is purchasing the item that was featured on the website or profile.

Returning to the previous example of a search for a local deli, according to one embodiment of the present invention the first step is when a user has discovered the merchant portal service via the submission of registration information. The user registers by submitting a last name and the last four digits of a credit card. Using this information, the merchant portal builds a user profile that can be associated with any searches conducted by the user. In addition, the financial database uses this information to identify the user based on preexisting financial data. A user may have with several different financial institutions a plurality of credit cards or the ability to conduct electronic payments. By submitting various information, the financial database can positively identify and match the user with all of their means to purchase an item whether it is the credit card possessing the last four digits of the user's profile or another credit card from a different financial institution. The user can also establish preferences and other characteristics such as geographic region, location or range of the search. A user with a cellular phone or PDA having GPS capability can base the search on a certain range from the location of the cellular phone/PDA. Other preferences also can be defined.

Thus, assume that the user searching for the deli registers with the merchant portal using a portion of his or her credit card number and his or her last name. Once registered, the merchant portal queries the financial database to positively identify the individual and associate any form of electronic payment with that individual profile. When the user logs into the merchant portal to conduct a search, the tokens that are generated are associated with each electronic payment means that the user possesses. Thus, when the user goes into a local deli within the predetermined time and buys a sandwich using a credit card, the present invention recognizes that the transaction by the user at this particular merchant correlates with a recently generated token. Accordingly, the merchant is charged a fee for the referral. As an incentive for the user to use his credit card rather than cash, the profile can advertise a discount should the user employ his credit card to purchase the product. As both the merchant and the user are part of the same financial network, i.e. the credit card transaction, a match based on an existing token is easy to accomplish using existing data.

According to another embodiment of the present invention, rather than generating an electronic token that can be used to electronically compare financial transactions at a merchant, a coupon can be generated by the merchant portal. Rather than rely on the use of a credit card or the like, a user is provided with a coupon that can be printed. The coupon then can be submitted for either a discount or a rebate. Upon submission of the coupon, the merchant agrees to assign a portion of the proceeds of the sale to the merchant portal system.

Alternatively and according to another embodiment of the present invention, the search generates a short message service (SMS) message. Rather than having to print a coupon, a PDA or cell phone can be used to convey to the merchant that a discount is warranted. In addition, the use of the code from the SMS registers the sale with the merchant portal thus incurring a fee to the merchant from the sale.

According to another embodiment of the present invention, the token generated by the present invention can be used for purely electronic purchases as well. Should a user be directed to a website by which a purchase can occur, the website acts as a surrogate for the brick and mortar merchant location. The correlation of the token with the merchant and the user remains the same.

One embodiment of the present invention incorporates the merchant portal into an established website. A “near-by” search could be conduct from an existing website to assist customers already associated with a particular website in conducting further commerce. For example, a customer knowing that it will be conducting business at a particular merchant can inquire what other establishment in the near vicinity offer goods based on several key words. Using the website's location as the point of origin for the search, a list of merchants can be provided that offer the goods sought. Again a token would be generated but according to this embodiment the token would be associated with the originating website. To track this form of transaction a coupon would be generated and associated with a credit card that the individual conducting the search intended to use. To gain a discount the individual must present the coupon and the credit card. The merchant would honor the discount listed on the coupon and upon the sale being recognized at the merchant via the registered credit card and/or coupon a fee payable to the merchant portal and hosting website by the merchant would be generated.

While certainly the merchant would like to conduct a sale without paying any sort of commission or referral fee, small entities cannot often compete with an entity conducting e-commerce. And since the cost is only associated with an actual sale and not projected or perspective sales, the only risk is one of diminished returns rather than no return. From the merchant's perspective, rather than paying for a website or an advertisement when they have no real idea whether that investment is producing any increase in revenue, the present invention monetizes website traffic. The merchant pays for only sales that occur as a result of the website (merchant portal) interaction.

One aspect of the present invention is the ability to deliver to a brick and mortar establishment that does not have a website of its own or one whose website has limited exposure, an avenue to effectively compete in e-commerce. Unlike a franchise establishment that can leverage a national brand, many local brick and mortar locations do not have the volume of Internet traffic to justify their establishment to be listed prominently on an organic Internet search. One embodiment of the present invention links the merchant profile with the merchant portal. By doing so a small brick and mortar location with limited exposure on the Internet can leverage the significant inquiries generally made on the merchant portal to their advantage. The association of the brick and mortar profile or website with the merchant portal can promote the merchants presence on the Internet significantly resulting in it being prominently displayed on applicable organic search results.

Embodiments of the present invention provide a merchant with the means to engage in Internet and electronic advertising without incurring any substantial risk. Rather than creating and supporting a website, a merchant can provide a merchant profile that can be accessed by the merchant portal. Upon that profile being recognized as matching an inquiry and upon that inquiry resulting in an actual sale, a portion of the proceeds from that sale is allocated to the merchant portal. Merchants that could not normally engage in e-commerce or advertise via the Internet can now compete with minimal exposure and minimal risk.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies and other aspects are not mandatory or significant, and the mechanisms that implement the invention or its features may have different names, divisions and/or formats. Furthermore, as will be apparent to one of ordinary skill in the relevant art, the modules, managers, functions, systems, engines, layers, features, attributes, methodologies and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver and/or in every and any other way known now or in the future to those of skill in the art of computer programming. Additionally, the present invention is in no way limited to implementation in any specific programming language, or for any specific operating system or environment.

While there have been described above the principles of the present invention in conjunction with website monetization, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A system for monetizing website interaction; the system comprising:
a merchant database wherein the merchant database includes a business establishment profile for each of a plurality of business establishments and wherein each business establishment profile includes a plurality of business characteristics;
a financial database maintaining merchant financial transactional data and individual financial transactional data;
a computing device capable of conducting an inquiry based on a desired product and a desired location;
a merchant portal communicatively coupled among the financial database, the merchant database and the computing device wherein responsive to the inquiry, the merchant database returns to the computing device for display on a display device a plurality of business establishments matching the inquiry and wherein a token is generated associating each of the plurality of business establishment with the inquiry.

2. The system of claim 1 wherein the computing device is a personal data assistant.

3. The system of claim 1 wherein the computing device is a personal communication device.

4. The system of 1 wherein the inquiry is associated with an individual financial transactional identity.

5. The system of claim 4 wherein the token associates with the individual financial transactional identity with the plurality of business establishments generated by the inquiry.

6. The system of claim 5 wherein the token is associated with the desired location.

7. The system of claim 5 wherein the token is associated with the desired product.

8. The system of claim 7 wherein responsive to the merchant portal matching merchant financial data from a sale at one of the plurality of business establishments with individual financial transactional identity data associated with the token, the inquiry is monetized.

9. The system of claim 8 wherein monetization of the inquiry includes allocating a portion of the sale proceeds to the merchant portal.

10. The system of claim 1 wherein said token is associated with a coupon presentable to the plurality of business establishments.

11. The system of claim 1 wherein said token is associated with a short message service message presentable to the plurality of business establishments.

12. The system of claim 1 wherein the plurality of business establishments are within a predetermined geographic distance from an identified location.

13. The system of claim 12 wherein the identified location is a global positioning satellite location of the computing device.

14. The system of claim 1 wherein the token expires after a predetermined period of time.

15. The system of claim 1 wherein the plurality of business characteristics includes a business establishment location and a product information list for goods offered at each of the plurality of business establishments.

16. A method for monetizing website interactions, the method comprising:
storing on a storage medium a business establishment profile for each of a plurality of business establishments wherein each business establishment profile includes a business establishment location and product information for goods offered at each business establishment;
maintaining a financial database wherein said financial database includes merchant financial transactional data and individual financial transactional data;
conducting on a computing device an inquiry for goods in a desired geographic location;
returning to the computing device for display on a display device a plurality of business establishments matching the inquiry; and
generating a token associating each of the plurality of business establishments with the inquiry, said token being correlated with the financial database.

17. The method of claim 16 wherein conducting includes associating the inquiry with an individual financial transactional identity.

18. The method of claim 17 wherein generating includes associating the token with the individual financial transactional identity.

19. The method of claim 18 further comprising matching merchant financial data of a sale conducted at one of the plurality of business establishments with the individual financial transaction identity associated with the token.

20. The method of claim 19 wherein matching includes associating the inquiry with the sale conduced at one of the plurality of business establishments.

21. The method of claim 16 wherein generating includes associating the token with the desired geographic location.

22. The method of claim 16 wherein generating includes associating the token with a desired product.

23. The method of claim 16 wherein said token is associated with a coupon presentable to one of the plurality of business establishments.

24. The method of claim 16 wherein said token is associated with a short message service message presentable to one of the plurality of business establishments.
